(19) United States
(12) Patent Application Publication
(10) Pub. No.: US 2007/0217290 A1
(43) Pub. Date: Sep. 20, 2007

(54) Lights out alarm clock assembly

(75) Inventor: David Rock, Solon, OH (US)

Correspondence Address: PERKINS COIE LLP;PATENT-SEA, P.O. BOX 1247, SEATTLE, WA, 98111-1247, US

(73) Assignee: Evergreen Innovation Partners, LLC, Evergreen, CO (US)

(21) Appl. No.: 11/385,135

(22) Filed: Mar. 20, 2006

(51) Int. Cl. G04B 47/00

(52) U.S. Cl. 368/12

(57) ABSTRACT

An alarm clock assembly of an embodiment of the present invention is provided that also turns off a non-integrated, connected lamp or other electrical device based on pushing a button on the clock. The alarm clock assembly also has input means for setting a timer to turn off the connected device and can also be programmed to turn on the connected, non-integrated device at a specified time or after a specific time period has elapsed. The alarm clock assembly can also regulate the electrical current in such a manner to dim or flash a connected device, such as a lamp.

### TECHNICAL FIELD

The present invention is directed toward clock assemblies, and more particularly toward alarm clock assemblies.

### BACKGROUND

The typical bedroom contains a bed, a nightstand, a light (either on the nightstand or somewhere else in the room), and an alarm clock. In most bedroom configurations, it is likely that turning off the light prior to going to sleep requires one to either get out of bed, or reach well outside of bed, to turn off the lights. In the event one must get out of bed to turn out a light, the return trip to the bed is often in complete darkness.

This is suboptimal since at the precise moment one is trying to be relaxed and comfortable and ready for sleep, you must engage in a movement or activity that is not conducive to falling asleep. In addition, children or elderly people may have particular difficulties navigating through a room in complete darkness.

Furthermore, many people read or watch TV prior to going to sleep, and it is not uncommon for people to fall asleep while reading or watching TV, which wastes electricity and requires one to at some point in the night wake up, and turn off the light or TV.

Therefore, it is desirable to make it easier to turn out the lights (or the TV) without getting out of bed. Various products have been developed and are known. For example, there are wireless remote control devices and home automation systems that can control electrical devices. GE and X10, for example, make a variety of wireless remote control devices that enable one to turn on or off a light at the touch of a button. However, these control units are new, incremental devices that clutter the nightstand. Furthermore, these solutions do not provide input means to turn off the device after a certain amount of time in a user-defined, flexible manner (e.g., turn off the light in 15 minutes).

It is also well known in the art that there are outlet controlling timers to turn on and off lights, electrical outlets, or other systems (e.g., irrigation systems) at specified (or random) times during the day. These devices, however, require pre-programming to specify certain on and off times, and cannot be programmed, for example, to turn the lights off after a selected time period has elapsed from any selected start time (e.g., turn the lights off in 15 minutes from now). Furthermore, these devices are designed to be located at an electrical outlet on the wall or at a switch plate location on the wall, and are not located on a nightstand within easy reach of the bed.

It is also well known in the art that there are wall plate dial timers that can replace a typical wall switch. These dial timers are often used with whirlpools or bathroom fans to turn a device on for a user-defined period of time (e.g., 3 minutes). These devices, however, typically control all electrical devices connected to that particular circuit, and cannot be directed to control a single electrical device while the rest of the device remains operational.

There also on the market is a product called “The Clapper” that switches a lamp on or off in response to a sharp handclap. This device is unable to control the light without a sharp, audible sound, so if one falls asleep, the device will leave the light on. Additionally, a sharp clapping sound prior to going to sleep is quite distracting.

There are also on the market products called Click Light and touch dimmer controls that either allows one to touch a metal lamp and turn it off, or to click a separate control to turn the light off. These products fail to have any programmable time delay. Furthermore, they either clutter the nightstand with additional products or they require that the light be easily within reach and made of metal.

U.S. Pat. No. 6,894,434 discloses a light control device that controls a nightstand light via a control unit. Again, however, the control unit clutters the nightstand with an additional device. And, furthermore, the control unit provides an integrated illumination member, which is frequently not desired as it creates illumination when none is desired.

It is also known in the art that certain devices such as TVs and radios have a “sleep” function that allows one to set the TV or radio, via remote control, to turn off at a certain time. There is no means, however, to “add” this function to an older radio or TV or to add it to a pre-existing light in a bedroom.

This invention overcomes limitations of the prior art inventions and provides other advantages as discussed below in the Detailed Description and shown in the Figures.

### SUMMARY

An alarm clock assembly is provided that overcomes drawbacks of the prior art and provided additional benefits. An alarm clock assembly in accordance with one embodiment of the present invention comprises an alarm clock having at least one of a timer mechanism, an alarm mechanism, and a clock. A first communication mechanism is coupled to the at least one of the timer mechanism, alarm mechanism, or clock. The first communication mechanism is configured to send or receive a control signal. A control unit is associated with the alarm clock and is couplable to the non-integrated electrical device and to the electricity source. The control unit controls electricity provided to the non-integrated electrical device in a manner related to the control signal. The control unit has a second communication mechanism that receives or sends the control signal.

An embodiment of the invention includes a method adjusting an operating condition of non-integrated electronic device. The method includes setting an alarm clock assembly with a countdown time period, providing a signal to a controller remotely located from an alarm clock upon expiration of the countdown time, and changing a flow of electricity provided to the non-integrated device coupled to the controller in response to the signal to adjust the operating condition of the non-integrated electronic device from a first condition to a second condition.

### BRIEF DESCRIPTION OF THE DRAWINGS

FIG. 1 is a schematic isometric view of a lamp on a nightstand, along with the alarm clock assembly in accordance with an embodiment, showing the alarm clock and the lamp electrically coupled together.

FIG. 2 is an enlarged isometric view of the alarm clock assembly of FIG. 1, with the lamp not shown for purposes of clarity.

FIG. 3 is an isometric view of an alarm clock assembly in accordance with an alternate embodiment of the invention.

FIG. 4 is a schematic isometric view of an alarm clock assembly of an embodiment shown remote from a wireless controller electrically coupled to a lamp assembly.

FIG. 5 is an isometric view of a wireless controller of the alarm clock assembly in accordance with another embodiment of the present invention.

FIG. 6 is an isometric view of an alarm clock assembly in accordance with another embodiment of the present invention.

FIG. 7 is an isometric view of an alarm clock assembly in accordance with another embodiment.

FIG. 8 is a schematic illustration of a flow chart showing a control program of the alarm clock assembly in accordance with one embodiment of the present invention.

A detailed description of the illustrated embodiments the invention is presented below, which will permit one skilled in the relevant art to understand, make, and use aspects of the invention. One skilled in the relevant art can obtain a full appreciation of aspects of the invention from the subsequent detailed description, read together with the Figures, and from the claims, which follow the detailed description.

### DETAILED DESCRIPTION

In the following description, numerous specific details are discussed to provide a thorough and enabling description for embodiments of the invention. One skilled in the relevant art, however, will recognize that the invention can be practiced without one or more of the specific details. In other instances, well-known structures or operations are not shown or are not described in detail to avoid obscuring aspects of the invention. In general, alternatives and alternate embodiments described herein are substantially similar to the previously described embodiments, and common elements are identified by the same reference numbers.

Alarm clock assemblies for use with a non-integrated lamp or other electrical device are described in detail herein in accordance with embodiments of the present invention. This alarm clock assembly enables a user to turn a separate electrical device on or off via control buttons on the alarm clock. The user may elect to turn the separate device on or off instantly, or after a certain number of minutes have elapsed. In one embodiment, if a light is connected to the alarm clock assembly, the alarm clock may be set to gradually dim the light or gradually turn it on to full brightness. The alarm clock assembly may be set to provide a visual or auditory indication that it is about to turn off the light by gradually dimming the light, or beeping, pausing, and then completely dimming the light, or it may pulse the electric flow to make the lights blink. The alarm clock assembly may also be programmed to turn the separate device on at a specific time, and in the case of a light being connected, may either gradually turn on the light, or only turn the light on to a dimmed level to provide subtle lighting as part of a morning wake-up routine during darkness.

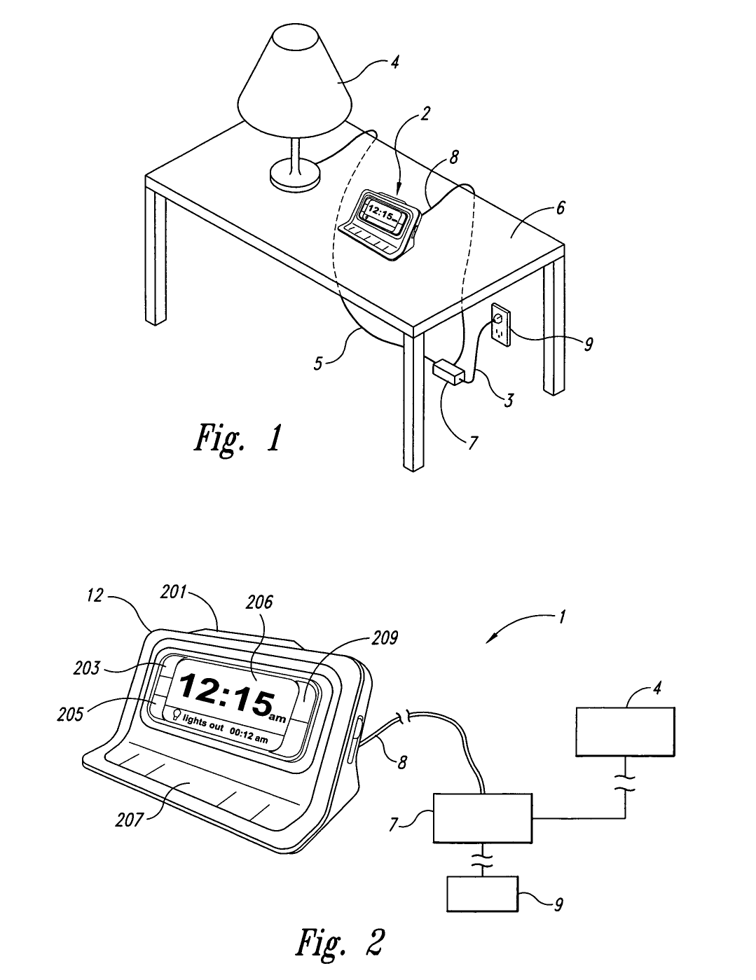

FIG. 1 is a schematic isometric view of a lamp on a nightstand, along with an alarm clock assembly 1 in accordance with an embodiment, showing the alarm clock assembly and the non-integrated lamp 4 electrically coupled together. The alarm clock assembly 1 includes an alarm clock 2 that has a cord 8 which connects to a device controller 7. In the illustrated embodiment, the alarm clock 2 is preferred to be of a digital clock type, although other embodiments can use other clock mechanisms. As can be seen from the illustration, the lamp 4 is also connected to the device controller 7, which is connected to an electrical source 9, such as a wall outlet, via a power cord 3. Accordingly, the lamp 4 is a non integrated electronic device coupled to the device controller 7. The device controller 7 can also be coupled to a non-integrated electronic device other than a lamp (e.g., a television, a fan) that will be controlled by the alarm clock assembly 1. In this particular embodiment, electricity is continuously supplied to the alarm clock 2 via the power cord 3, through the controller 7 and then through the cord 8. The cord 8 of the illustrated embodiment also provides a signaling wire for the alarm clock 2 to signal the controller 7 to provide electrical current to the lamp 4 via the lamp's power cord 5. The alarm clock 2 is shown on a nightstand table 6 generally adjacent to the lamp 4, although the alarm clock 2 and the lamp can be remotely located relative to each other, within the same room or in separate rooms. An alternative embodiment to this expanded illustration is that the controller 7 could plug directly into an outlet 9 or other power source and obviate the need and expense of the power cord 3.

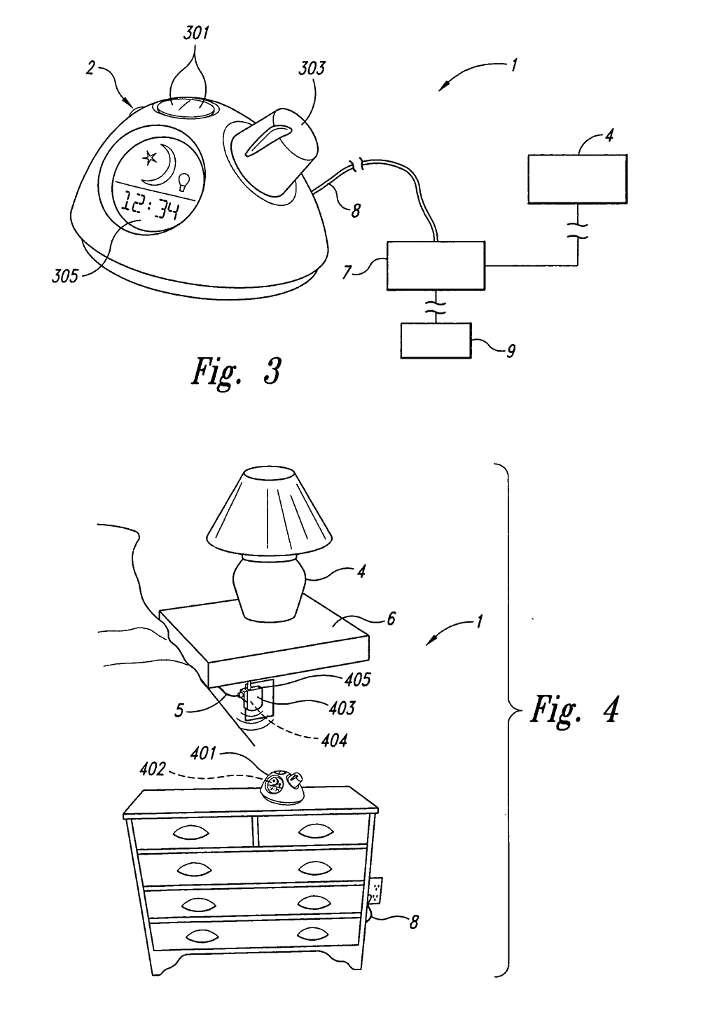

FIG. 2 is an enlarged isometric view of the alarm clock 2 with the lamp not shown for purposes of clarity, and FIG. 3 is an isometric view of an alarm clock 2 in accordance with an alternate embodiment. In FIG. 2, the alarm clock 2 has a button 201 that acts as a master switch for the lamp 4 connected to the controller 7 (shown schematically). When the button 201 is pressed, a signal is sent via the cord 8 to the signal controller 7. In response to such signal, controller 7 will control the electricity provided to the lamp 4, such as to turn on or off the lamp 4 or to control other operational aspects of the lamp 4 or other non-integrated device connected to the controller 7.

As an alternative for using the master switch to turn on, off, or otherwise control the lamp 4, the alarm clock 2 can be configured with a plurality of setting buttons or other input devices operatively coupled to features of the alarm clock, such as a countdown timer. The setting buttons and countdown timer are configured (programmed or programmable) to set the countdown time period selected by a user. Setting buttons and countdown timer are configured so the countdown time period can be adjusted in selected increments, such as 10-min, 5-minute, 1-minute, or 1-second increments. Other time increments could be used. The setting buttons allow a user to set the time to a customized countdown time period after which the alarm clock 2 sends a signal to the controller 7 and the controller is configured to turn off, dim, flash, or otherwise control the lamp (or other non-integrated device). In FIG. 2, a countdown timer 205 of the alarm clock 2 is illustrated as are and pre-set buttons 209 that allow one to activate the alarm clock to turn off the light 4 after expiration of a pre-set amount of time. One could also use the buttons 203 to set or re-set the timer to a more customizable length of time by incrementing or decrementing the remaining time by 1 minute or other selected time intervals. Time remaining until the light 4 is turned off or otherwise adjusted can be displayed in display area 206. In one embodiment, the alarm clock 2 is configured with a “reverse snooze” feature that is activated through the controls 207. Upon activation of the “reverse snooze” feature by depressing at least one of the controls 207, thereby adding a fixed period of time, e.g., 5 or 10 minutes, to the elapsed time countdown before the lamp 4 or other non-integrated device is automatically turned off or otherwise adjusted.

Traditional alarm clock controls such as setting the clock, or setting the alarm are performed using the controls 207. Setting the alarm clock 2 to activate the controller 7 to turn on the lamp 4 is also programmed through the controls 207. In another embodiment, a sliding switch on the side of the alarm clock 2 enables a user to choose if the light 4 should be illuminated when an audible alarm (e.g., a tone, a buzzer, a beeping, a radio, or other noise) goes off or is otherwise activated. In yet another embodiment, the controls 207 and display area 206 give the user control over whether the lamp 4 should come on full brightness immediately or gradually. The controls 207 and display area 206 also give the user control over whether the lamp 4 should come on at a user-defined level of brightness (e.g., 30%) so as to provide some low level of light to aid in navigating the bedroom in darkness, but not full intensity light so as to wake others in the bedroom. In yet another embodiment, a button is provided on the alarm clock 2 and is configured so that, when pushed or otherwise activated, the alarm clock 2 provides a signal to the controller 7 to control the lamp 4, such as to illuminate the lamp at 30% brightness for a predetermined period of time (e.g., 5 minutes). Such a button could be useful for when one needs to make a trip to the bathroom and provide temporary, subtle illumination for the room.

As FIG. 3 illustrates in an alternative embodiment, the alarm clock 2 has a knob controller 303 with a plurality of control positions to which the knob controller can be set to control the lamp 4. For example, in the illustrated embodiment, the knob controller 303 can be set to “fade” or “pulse” or “hard on/off”, and the alarm clock 2 is configured and programmed to provide a signal via the signal control wire 8 to the controller 7 about how to regulate the electrical current when turning on or off the lamp 4 or other non-integrated electrical device. That is, when the knob controller 303 is set to the “fade” position, a signal is provided from the alarm clock 2 to the controller 7, which dims the light at a selected time period before turning the light off. For example, in one embodiment the alarm clock 2 and controller 7 are configured so the light 4 will dim and remain dimmed for two minutes before controller turns off the light. The alarm clock 2 in one embodiment is configured so the user can program when the controller 7 will dim the light during the countdown period. In one embodiment, the alarm clock 2 and controller 7 are configured so the lamp 4 can be dimmed to different brightness levels during the countdown period.

When the knob controller 303 is set to the “pulse” position, the alarm clock 2 and controller 7 are configured to pulse or flash the light at a selected time prior to completely turning it off. This feature is of particular value when one might want to read for 30 minutes and then go to sleep. As an example, with one minute of remaining time, the controller 7 could dim the lamp 4 to 50% normal brightness, giving the reader time to put the book down and get comfortable. Then, when that final minute has elapsed, continue dimming the light down to 0%. Or alternately, with one minute of remaining time, the controller 7 could quickly turn off and on the power to the lamp 4 one or more times, effectively “blinking” the light and signaling to the reader that it was time to put the book down before the light is turned off.

In another embodiment represented in FIG. 3, the buttons 301 provide the input means that allow a user to program how much time should elapse prior to turning off the lamp 4, and the display 305 could alternate between showing the current time and remaining time for lamp 4 to be on.

FIG. 4 is a schematic isometric view of the alarm clock assembly 1 with a wireless controller 403 electrically coupled to a lamp assembly. In the illustrated embodiment, the controller 403 is an integrated version of the controller 7 and the cord 3 discussed above. The controller 403 is operatively connected to the power source (e.g., an electrical outlet), and the controller has an integral outlet 404. The lamp 4 or other non-integrated electrical device plugs directly into the outlet 404 in the controller 403. In this illustrated embodiment, the alarm clock 401 is substantively similar in design to the alarm clock 2 discussed above, except that communication between the alarm clock 401 and the controller 403 happens wirelessly, such as via an RF signal being transmitted at a selected frequency. Accordingly, the alarm clock 401 could be located at some distance from the controller 403 and the lamp 4. The alarm clock 401 is configured with a transmitter 402 or other signal generating device that provides a signal to the controller 403. The controller 403 has a receiver 405 or other signal receiving device that receives the signal. The controller is configured to control the power provided to the lamp 4 or other non-integrated electrical device connected to the controller. In one embodiment, the alarm clock 401 could be battery operated (e.g., with traditional AA, C, D or even 9-volt batteries), further reducing wire clutter. The controller 403 could also contain or be connected to an alternate power source, such as batteries, that could power the controller 403 and the lamp 4 or other non-integrated electrical device.

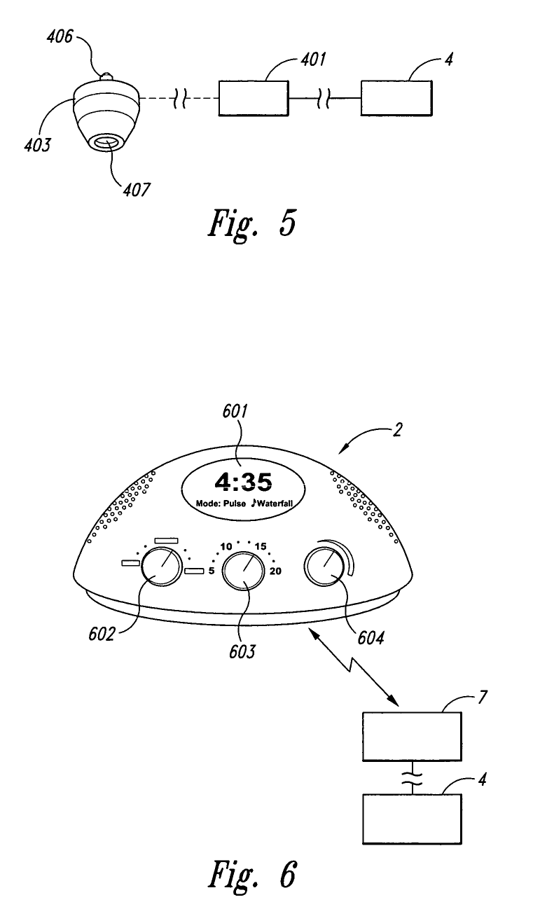

In some homes, there is no separate lamp in the bedroom— all light is provided by light fixtures that have been built into the room's ceiling or walls, such as can lights or a ceiling fan. In another embodiment, the controller 403 is a wireless controller having the characteristics of a light socket insert illustrated in FIG. 5. The wireless controller 403 of the illustrated embodiment is configured to screw into a light socket 406, and a light bulb (not shown) can be screwed into a receptacle 407 of the wireless controller 403. This arrangement is particularly suitable for rooms wherein all light is provided from hard wired fixtures, such as can-lights, track lights, ceiling fans, or other light fixtures. In this embodiment shown in FIG. 5, the controller 403 receives wireless signals, such as RF signals at a selected frequency, from the alarm clock 401. The controller 403 is configured to regulate the electricity flow to the light bulb or other non-integrated electrical device screwed into or otherwise connected to the receptacle 407.

FIG. 6 illustrates another embodiment of the invention and shows a unique way of configuring the alarm clock 2 (hard wired or wireless) using dials 602, 603, 604 that are turned and pushed by a user, and a display screen 601 that can display the time and/or the remaining time until the light or other non-integrated electrical device is turned off. In the illustrated embodiment, the dial 602 is configured to enable the user to easily adjust the programming of the mode for controlling the light. The dial 602 can be moved to a plurality of positions, and indicia are provided on the alarm clock 2 adjacent to the dial 602 to indicate the modes associated with the different positions. For example, the alarm clock 2 is configured with modes and associated positions of the dial 602 for a range of fade-to-off, switch-to-off, and pulse or blink the lamp prior to turning it off.

In the illustrated embodiment, the dial 603 can be moved to a plurality of positions associated with a countdown timer mode of the alarm clock 2 that allow a user to dial in a selected amount of delay until a signal is provided from the alarm clock 2 to the controller 7 (shown schematically) to turn off, or otherwise adjust the lamp 4. After turning the dial to the desired amount of time, the user simply pushes the dial 603 to activate the countdown timer. In the illustrated embodiment, dial 604 can be moved to a plurality of positions to control the backlight of the alarm clock 2. The alarm clock 2 can be programmed to adjust the backlight to be any of a plurality variety of colors by rotating the dial 604. This feature enables the alarm clock 2 to match the decor of a particular bedroom. It also enables the user to select a color that is more pleasing to them in the darkness for seeing the digital display of the alarm clock 2.

In another embodiment, the controller 7 or the alarm clock 2 generates an RF signal and send a power-on or power-off signal to a television or stereo. This is done via a “learning” remote function that captures the RF frequency from a pre-existing remote control for a device, such as a television or stereo, and then replicates such RF signal when the countdown timer reaches zero. In an alternate embodiment, the alarm clock 2 and/or the controller 7 can be pre-programmed at the time of manufacture with the most common RF codes for various branded televisions, stereos, or other electronic devices. The control areas 207 or 301 and display areas 205 or 305 or the alarm clock 2 can be used to select the appropriate device that the user desires to control.

Yet another embodiment includes the controller 7 as an integral component of the alarm clock 2 and its circuitry to eliminate an additional physical housing for the controller 7 and consequently reduce cost. In such a configuration, the regulation of electricity to the non-integrated electrical device is managed by a power regulator also contained within the alarm clock assembly.

In another embodiment of the invention, additional audio or visual signaling mechanisms are included in the alarm clock 2 to indicate that the lamp 4 is about to be turned off. These can include, as an example, a flashing display, colored lights on the alarm clock, and/or an audible tone. Other embodiments can use other audible and/or visual indicators.

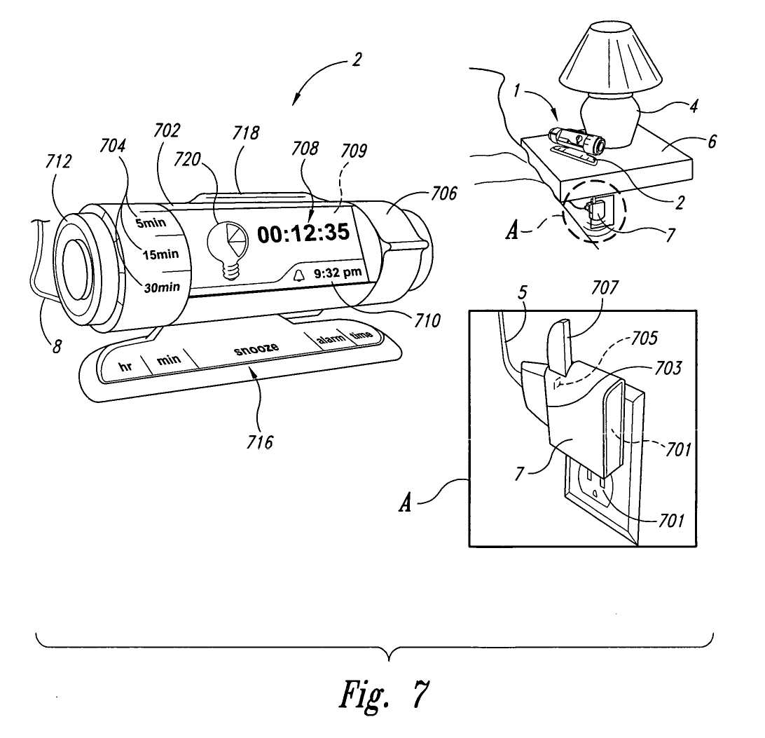

FIG. 7 is an isometric view of another embodiment of the alarm clock assembly 1 with the alarm clock 2 coupled to the controller 7 (hard wired or wireless) and the lamp 4 or other non-integrated electrical device as discussed above. The controller 7 of the illustrated embodiment is a wireless unit that has a conventional male plug with two or three prongs that removable plugs into a wall socket 701 or electrical outlet. The controller 7 also has an electrical outlet 703 into which the lamp 4 or other non-integrated electrical device removably plugs. The controller 7 regulates or controls the power provided from the electrical outlet 703 to the lamp 4. The controller of the illustrated embodiment had a receiver 705 with an antenna 707, such as an RF receiver, that communicates wirelessly with a transmitter 709 in or coupled to the alarm clock 2.

The alarm clock 2 of the illustrated embodiment has a generally tubular-shaped body 702 with a three pre-set time buttons 704 that control the duration of the countdown timer of the alarm clock. While the illustrated embodiment provides separate buttons 704 for 5-minute, 15-minute and 30-minute countdown-time durations, other time durations could be used and greater or fewer buttons could be used. The alarm clock 2 also has a manual time-adjustment device 706 coupled to the countdown timer 708 that allows a user to set or adjust the countdown-time duration at a selected increment, such as 1-minute, 30-second, or 1-second increments.

The alarm clock 2 has a display 710 that shows the actual time (including daytime and night time), and the countdown-time period remaining (when the countdown timer 708 is activated) before the alarm clock provides the signal to the controller 7 via the transmitter and the receiver. The display 710 can be a lighted display, such as a back lighted display. The alarm clock can also include a light 712, such as a colored personality light that provides some illumination of the alarm clock 2 for better visibility of the alarm clock's control features in a dark environment. The alarm clock 2 of the illustrated embodiment is also configured with a plurality of control features 716, such as buttons and switches that control the alarm and time-of-day features of the clock. The alarm clock 2 can also include a snooze button system 718 coupled to the alarm feature.

In the illustrated embodiment, the alarm clock 2 is also configured and programmed to provide an icon 720 on the display 710 that graphically or pictorially indicates the countdown-time period. The icon 720 is illustrated as having a light-bulb shape with a pie-chart style reference frame or indicator provided that indicates the time remaining in the countdown period. Other embodiment, however, can have other icons or images that graphically or pictorially indicate the countdown-time period. The icon 720 allows the user to easily and quickly determine the amount of time remaining before the alarm clock 2 sends the signal to the controller 7 to terminate or otherwise adjust the electricity flow to the lamp 4, thereby controlling the lamp without requiring the user to physically touch or otherwise engage the lamp. Accordingly, a person can set the countdown timer 708 of the alarm clock 2, and lay down or fall asleep while being assured that the lamp 4 while turn off after a selected time period has elapsed.

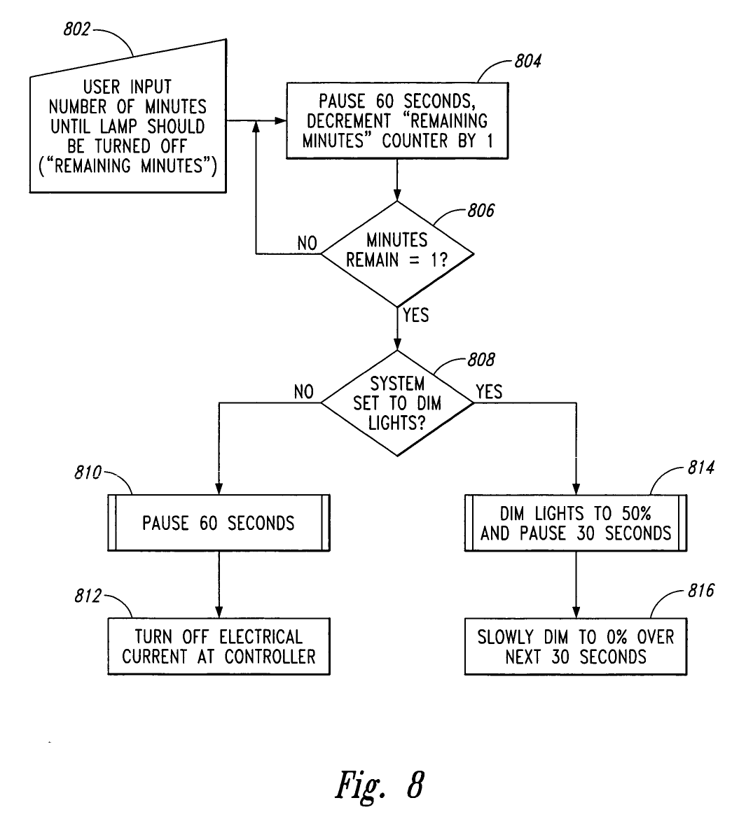

FIG. 8 is a schematic illustration of a flow chart showing a control program of the alarm clock assembly in accordance with an embodiment of the present invention. In block 802, the user activates the controls or buttons on the alarm clock 2 and inputs the time period (e.g., number of minutes) until the alarm clock 2 provides a signal to the controller to turn off the lamp 4. As an example, a parent could use the alarm clock assembly to assist a child in the process of going to sleep, by leaving the lamp on and programming the alarm clock assembly to turn the lamp off after 25 minutes (or any other selected time period). The user can also program how the alarm clock 2 and controller 7 turns off the lamp 4, such as by turning off the lamp at once, or by dimming the lamp, or with a “notice” flash of the lamp before the lamp is turned off. While this example is described in connection with controlling a lamp, the alarm clock assembly could be used in a similar manner to control other non-integrated electrical devices.

After the countdown timer of the alarm clock 2 has been set and activated, the alarm clock monitors how much time has elapsed from the set countdown time. The amount of remaining time is provided on the display of the alarm clock (e.g., numerically, graphically, pictorially, or any combination of thereof). The controller continues to allow power to the lamp so it can remain on (unless the lamp is independently or manually turned off by a user). Accordingly, the child can be in bed and begin to relax and try to fall asleep while the lamp 4 remains on.

In the illustrated embodiment, the countdown timer and the alarm clock are programmed to pause for sixty seconds before decreasing the amount of remaining time by 1 minute, as shown in block 804. In block 806, the alarm clock poles the countdown timer and determines whether the remaining time equals one minute. If the remaining time is greater than one minute, the countdown timer continues and the program returns to block 804. If the remaining time equals one minute, the alarm clock is programmed to determine if the system is set to dim the lights, as seen in block 808. The alarm clock 2 can similarly determine if the system is set to flash or pulse the lights. If the system is not set to dim the lights, the alarm clock 2 will pause for sixty seconds, as shown in block 810, and then the alarm clock will provide a signal to the controller 7 at block 812 to terminate electrical power to the lamp 4, thereby automatically turning off the lamp. Accordingly, if the child of the above example is going to sleep or has fallen asleep during the countdown time, the lamp is automatically turned off after the countdown time has fully elapsed.

If the system is set to dim the lights, the alarm clock 2 is programmed to send dim the lights to 50% of the brightness and pause for thirty seconds, shown at block 814. After the thirty seconds has elapsed, as shown in block 816, the alarm clock 2 provides one or more signals to the controller 7 to slowly dim the lamp from 50% down to 0% (i.e., off) over the remaining thirty seconds. The controller 7 can be configured to control the power to the lamp 4 to dim the light in a series of sequential steps or substantially continuously over the remaining thirty seconds. While the above example dims the light over a one minute period, other time period and dimming sequences could be used. If the child of the above example is close to falling asleep, the dimming of the light can help the child to fall asleep smoothly and comfortably without an abrupt change of lighting in the room. If the child of the above example is reading, the dimming of the light provides an indication that the lamp will turn off in a set period of time. The dimmed light, however, provides enough light that allows the child to continue reading for a short period of time, such as to finish a sentence or paragraph, close the book, and put the book away before the lamp 4 turns off.

In another embodiment, the alarm clock 2 and controller can be configured to cause the lamp 4 (or other non-integrated device) to flash off and on one or more times in five minutes (or any other a selected time period) before the countdown time has fully elapsed. The flashing of the lamp could be accompanied with dimming of the light. The flashing (and/or dimming) of the lamp would provide an indication that the lamp will automatically be turned off in five minutes.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I/We claim:

1. An alarm clock assembly couplable with a non-integrated electrical device powered by electricity from an electricity source, comprising:
an alarm clock having at least one of a timer mechanism, an alarm mechanism, and a clock, and a first communication mechanism coupled to the at least one of the timer mechanism, alarm mechanism, or clock, the first communication mechanism being configured to send or receive a control signal; and
a control unit associated with the alarm clock and couplable to the non-integrated electrical device and to the electricity source, the control unit configured to control electricity provided to the non-integrated electrical device in a manner related to the control signal, the control unit having a second communication mechanism that receives or sends the control signal.

2. The assembly of claim 1 wherein the alarm clock is configured to generate the control signal to the control unit after an identified amount of time has elapsed.

3. The assembly of claim 1 wherein the alarm clock has the countdown timer coupled programmable with an amount of countdown time, and the alarm clock is configured to generate the control signal after the identified amount of time has elapsed.

4. The assembly of claim 1 wherein the alarm clock has the countdown timer and a display, the countdown timer is programmable with an amount of countdown time, and the display that simultaneously displays a time-of-day and the remaining time of the countdown time.

5. The assembly of claim 1 wherein the first communication mechanism provides the control signal wirelessly to the second control mechanism.

6. The assembly of claim 1 wherein the first communication mechanism is an RF transmitter configured to generate an RF control signal, and the second communication mechanism is an RF receiver configured to receive the RF control signal.

7. The assembly of claim 1 wherein the control unit includes a first electrical connector connectable to a power source, and the control unit includes a second electrical connector connectable to a portion of the non-integrated electrical device.

8. The assembly of claim 1 wherein alarm clock has a countdown timer and a display, the countdown timer is programmable with an amount of countdown time, and the display is configured to display an icon that indicates an a remaining amount of the countdown time with the countdown timer has been activated.

9. The assembly of claim 1 wherein the alarm clock includes a programmable, audible alarm, first controls coupled to the audible alarm, a programmable countdown timer coupled to the first communication mechanism, second controls coupled to the countdown timer.

10. The assembly of claim 1 wherein the alarm clock includes a programmable countdown timer coupled to the first communication mechanism, a plurality of controls coupled to the countdown timer configured to allow a user to program the countdown time with a countdown time, the countdown time being adjustable in at least one of a plurality of time increments.

11. The assembly of claim 1 wherein the alarm clock includes a programmable countdown timer coupled to the first communication mechanism and being programmable with an amount of countdown time, and the alarm clock is programmable to cause the control unit to modify power provided to the non-integrated electrical device prior to expiration of the countdown time.

12. The assembly of claim 1 wherein the alarm clock includes a programmable countdown timer programmable with an amount of countdown time, and the alarm clock is configured to provide a first control signal to the control unit prior to the countdown time fully elapsing so the non-integrated electrical device experiences a change visually or audibly detectable by a user, and to provide a second control signal to the control unit upon the countdown time fully elapsing.

13. The assembly of claim 1 wherein the alarm clock is programmable to provide the control signal that causes the control unit to control the electricity to the non-integrated electrical device so the non-integrated electrical devices turns off, flashes off and on, or changes intensity of output.

14. The assembly of claim 1 wherein the non-integrated electrical device is a lamp, and the alarm clock is programmable to provide the control signal that causes the control unit to cause the lamp to turn off, flashes off and on, or changes intensity of output.

15. The assembly of claim 1 wherein the control unit is configured to screw into a light socket, the control unit having a receptacle that can operatively receive light bulb.

16. An alarm clock assembly couplable with a non-integrated electrical device, comprising:
an alarm clock;
and a control unit associated with the alarm clock for regulating electricity to the non-integrated electrical device connected to the control unit;
wherein the control unit receives a signal from the alarm clock assembly to regulate the electricity to the non-integrated electrical device and the signal is transmitted to the controller by a radio frequency transmitter coupled with the alarm clock assembly and a radio frequency receiver coupled with the control unit.

17. The invention of claim 16 wherein the alarm clock sends the signal to the control unit after a defined amount of time has elapsed.

18. The invention of claim 17 wherein the alarm clock can be programmed by a user for a specific amount of time delay.

19. An alarm clock assembly couplable with a radio frequency transmitter, comprising:
an alarm clock;
and a control unit associated with the alarm clock for transmitting a radio frequency signal to a remote device after a defined amount of time has elapsed.

20. An alarm clock assembly couplable with a non-integrated electrical device, comprising:
an alarm clock;
and a control unit associated with the alarm clock for regulating electricity to the non-integrated electrical device connected to the control unit;
wherein the control unit receives a signal from the alarm clock assembly to regulate the electricity to the non-integrated electrical device after a user-specified amount of time has elapsed.

21. The invention of claim 20 wherein control unit is configured to regulate the electricity provided to the non-integrated electrical device in a manner that would dim or flash the brightness of the non-integrated electrical device.

22. The invention of claim 20 wherein the control unit has a connection portion configured to screw into a light socket, the control unit has a receptacle configured to receive a light bulb therein.

23. A method of adjusting an operating condition of non-integrated electronic device, comprising:
setting an alarm clock assembly with a countdown time period;
providing a signal to a controller remotely located from an alarm clock upon expiration of the countdown time;
changing a flow of electricity provided to the non-integrated device coupled to the controller in response to the signal to adjust the operating condition of the non-integrated electronic device from a first condition to a second condition.

24. The method of claim 23 wherein the non-integrated electronic is a light-generating device, and changing the flow of electricity includes adjusting the operating condition from the first condition with a first illumination level to the second condition with a second illumiriation level different than the first illumination level.

25. The method of claim 23, further comprising causing the non-integrated electronic device to dim from the first condition to an intermediate condition prior to changing the second condition.
